(19) United States
(12) Patent Application Publication
(10) Pub. No.: US 2014/0035708 A1
(43) Pub. Date: Feb. 6, 2014

(54) MAGNETIC ACTUATORS HAVING A NANOCOMPOSITE MEMBRANE

(71) Applicants: Athanasia Athanasiou, Ceranesi (Genova) (IT); Massimo De Vittorio, Lecce (IT); Despina Fragouli, Genova (IT); Simona Petroni, San Cesario di Lecce (Lecce) (IT); Gabriele Nanni, Genova (IT); Massimiliano Amato, Bari (IT); Daniela Lorenzo, Monteroni di Lecce (Lecce) (IT); Roberto Cingolani, Ceranesi (Genova) (IT)

(72) Inventors: Athanasia Athanasiou, Ceranesi (Genova) (IT); Massimo De Vittorio, Lecce (IT); Despina Fragouli, Genova (IT); Simona Petroni, San Cesario di Lecce (Lecce) (IT); Gabriele Nanni, Genova (IT); Massimiliano Amato, Bari (IT); Daniela Lorenzo, Monteroni di Lecce (Lecce) (IT); Roberto Cingolani, Ceranesi (Genova) (IT)

(73) Assignee: FONDAZIONE INSTITUTO ITALIANO DI TECNOLOGIA, Genova (IT)

(21) Appl. No.: 14/111,769

(22) PCT Filed: Apr. 19, 2012
(86) PCT No.: PCT/IB2012/051976

§ 371 Date: Oct. 15, 2013

(30) Foreign Application Priority Data
Apr. 20, 2011 (IT) TO2011A000347

(51) Int. Cl. H01F 7/06; H01F 41/02

(52) U.S. Cl. CPC H01F 7/06; H01F 41/02
USPC 335/296; 427/550

(57) ABSTRACT

Magnetic actuators are provided having a substrate, a membrane layer directly or indirectly applied on a surface of the substrate, in which the membrane layer consists of a matrix of elastic polymer material, in which nanoparticles of magnetic material, capable of undergoing a dynamic effect under the action of a magnetic field, are dispersed, and at least one magnetic field generator suitable to generate a magnetic field acting on the membrane layer, in which the magnetic field generator is directly or indirectly arranged on the surface of the substrate, or within the substrate.

The present invention relates to a magnetic actuator, comprising
a substrate,
a membrane layer directly or indirectly applied on a surface of the substrate, said membrane layer consisting of a matrix of elastic polymer material, in which nanoparticles of magnetic material, capable of undergoing a dynamic effect under the action of a magnetic field, are dispersed, and
generator means suitable for producing a magnetic field acting on the membrane layer.

Sensor and actuator devices are known, which are provided with polymeric membranes.

Generally, the use of electro-active polymers (EAP) allows producing membranes capable of operating as actuator or sensor element. Among such polymers, those activated by a field, such as the dielectric elastomers and the piezoelectric materials, generate high actuation forces, but they need high actuation voltages (Yoseph Bar-Cohen, “Electroactive polymers for refreshable Braille displays”, Industrial Sensing & Measurement, Sep. 11, 2009, SPIE Newsroom); on the other hand, ionic EAP materials (conductive polymers and ionic polymer-metal composites) are attractive due to their low actuation voltage, but the generated force is low. In the EAP approach, two problems have not yet been solved: a low voltage and a high actuation force are not compatible, and the life cycle of the polymers is too short.

Thermal-pneumatic membranes have been produced in elastic polymer material, in particular, polydimethylsiloxane (PDMS), for Braille display applications (Hyuk-Jun Kwon, Seok Woo Lee, Lee, S. S., “Braille code display device with a PDMS membrane and thermopneumatic actuator”, Micro Electro Mechanical Systems, 2008. MEMS 2008. IEEE 21st International Conference on), but such architecture requires a resistive heater to convert a liquid flowing within a cavity into a vapour and generate such a high pressure as to deflect a hanging membrane. The presence of high temperatures and vapours is a clear drawback of such an actuation mechanism. Furthermore, the response time required in order to reach the maximum deflection is higher than 10 seconds (Hyuk-Jun Kwon, Seok Woo Lee, Seung S. Lee, “Braille dot display module with a PDMS membrane driven by a thermopneumatic actuator”, Sensors and Actuators A, 154 (2009) 238-246).

In the magnetic actuation field, the known solutions generally exploit a PDMS membrane carrying a micromagnet (J. Streque, A. Talbi, P. Pernod, V. Preobrazhensky, “New Magnetic Microactuator Design Based on PDMS Elastomer and MEMS Technologies for Tactile Display”, IEEE Transactions on haptics, Vol. 3, No. 2, April-June 2010; M. Benali-Khoudja, M. Hafez, and A. Kheddar, “VITAL: An Electromagnetic Integrated Tactile Display”, Displays, vol. 28, no. 3, pp. 133-144, April 2007). The main drawback of such solutions is due to the adhesion between the rigid material and the flexible membrane, which is not complete, and often requires special arrangements and mechanic stops in order not to collapse on the magnetic generator. Furthermore, to avoid possible failures, due to their mutual attraction, the permanent magnet and the microgenerator are very spaced apart, thus determining an increase in the final dimensions of the device.

Publication WO 2008/106928 discloses a device of the type defined in the beginning, in which an electromagnet is positioned above the membrane to implement a pump or a switch. When the membrane is still in a viscous form, microcoils are used in order to cause a thickening and alignment of the nanoparticles in preset sites of the membrane. Once hardened, the membrane is attached to a substrate. The solution described in WO 2008/106928 determines a relative compactness of the device, since the magnetically active component is incorporated in the polymeric membrane.

An object of the invention is to provide a magnetic actuator, which allows a further integration of the components, and therefore which allows achieving a higher compactness of the device, as well as a better yield.

With a view to such aim, it is the object of the invention an actuator of the type defined in the beginning, in which said generator means comprise at least one magnetic field generator directly or indirectly arranged on said surface of the substrate, or within said substrate.

According to such idea of solution, the whole actuator can be produced by the thin film deposition and processing technologies, thus allowing obtaining a higher compactness and a better yield compared to the known solutions.

Furthermore, it is the object of the invention a method for producing a magnetic actuator, comprising the following steps:
providing a substrate,
directly or indirectly applying on a surface of the substrate a membrane layer consisting of a matrix of polymer material, in which nanoparticles of magnetic material, capable of undergoing a dynamic effect under the action of a magnetic field, are dispersed, and
applying generator means suitable for producing a magnetic field,
in which said applying generator means comprises directly or indirectly forming at least one magnetic field generator on said surface of the substrate or within said substrate, before applying the membrane layer.

Further characteristics and advantages of the actuator according to the invention will be apparent from the following detailed description, provided with reference to the annexed drawings, given by way of non-limiting example only, in which:

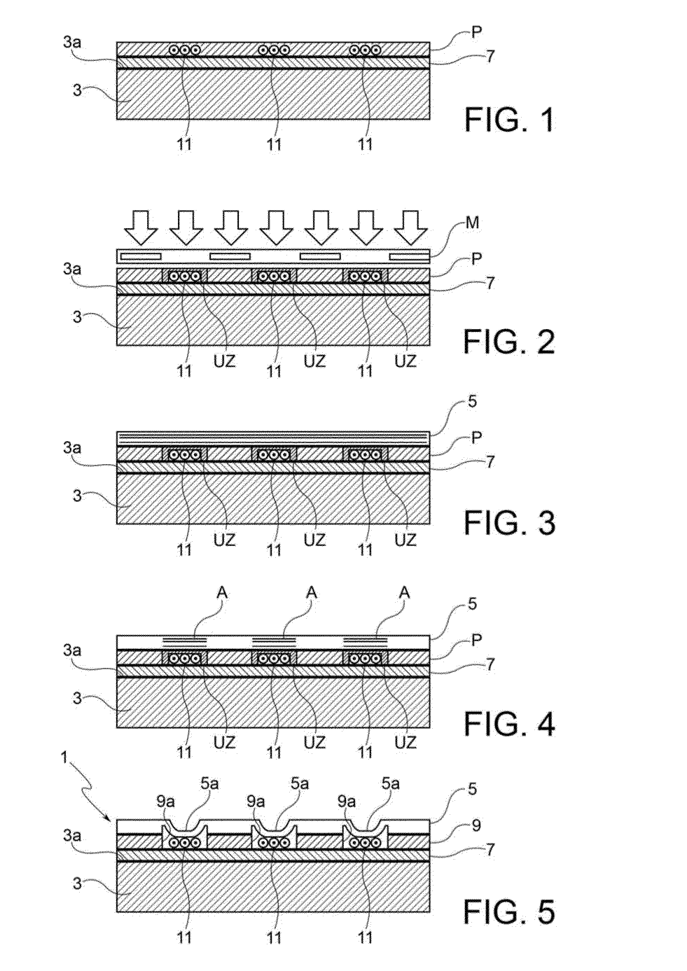

FIGS. 1 to 5 are schematic drawings illustrating corresponding operative steps of a method for producing a magnetic actuator according to the invention;

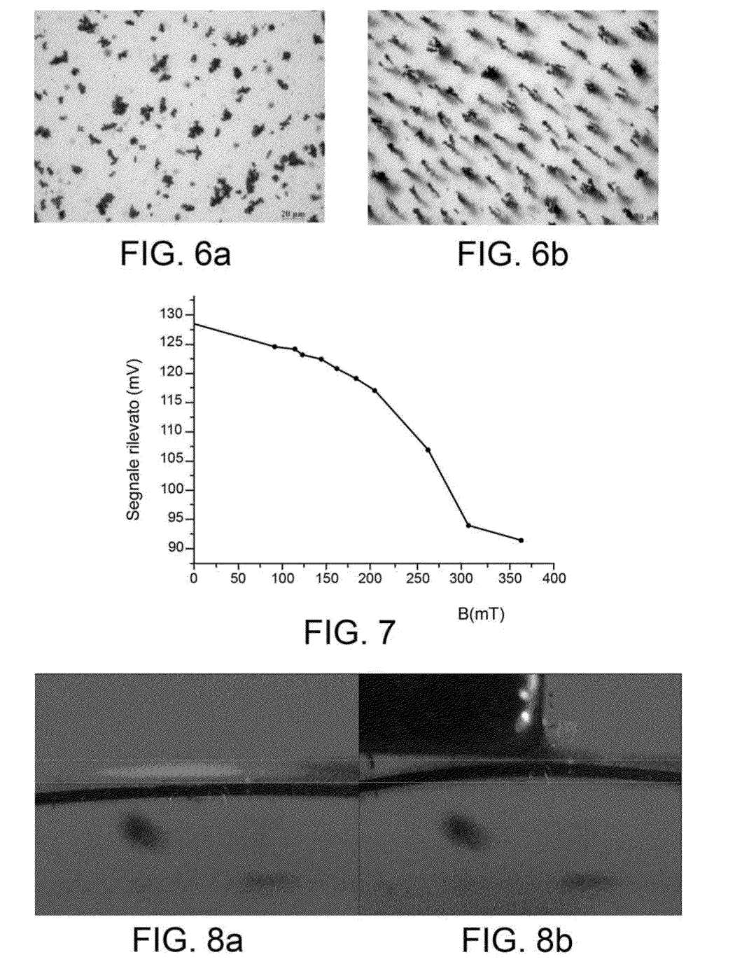

FIGS. 6a and 6b are photographs representing nanoparticles disperses in a fluid polymeric matrix, respectively before and after the application of an external magnetic field;

FIG. 7 is a graph setting forth electro-optical measurements that are indicative of the deflection of a membrane incorporating magnetic nanoparticles, as a function of the intensity of an external magnetic field; and

FIGS. 8a and 8b are photographs of a membrane incorporating magnetic nanoparticles, under a deflection due to the action of external magnetic fields having different intensity.

With reference to the FIG. 5, a magnetic actuator is schematically represented and indicated by 1.

Such an actuator comprises a substrate 3 and a membrane layer 5 directly or indirectly applied (in particular, deposited) on a surface 3a of the substrate 3.

The substrate 3 is, for example, in doped n-type silicon having a low resistivity.

In the illustrated example, the membrane layer 5 is indirectly deposited on the surface 3a of the substrate 3, i.e., further materials forming intermediate layers are interposed between it and the substrate 3, particularly, an insulating layer 7 and a support layer 9, which will be described in more detail herein below.

According to further non-illustrated implementation modes, the membrane layer could be directly deposited on the substrate, i.e., without further layers of material interposed between it and the substrate.

The membrane layer 5 consists of a matrix of elastic polymer material, in particular, polydimethylsiloxane (PDMS), in which nanoparticles of magnetic material, capable of undergoing a dynamic effect under the action of a magnetic field, are dispersed. To the aims of the present invention, by nanoparticles are meant particles having dimensions lower than 1 μm, as small as a few nanometers. Such nanoparticles can be of paramagnetic or ferromagnetic material. In order to preserve the polymer elasticity, the wt. concentration of the particles is kept at a low level, of the order of a few percentage points.

The actuator 1 further comprises generator means suitable for producing a magnetic field acting on the membrane layer 5, which comprise at least one magnetic field generator 11 directly or indirectly arranged on the surface 3a of the substrate 3, or within the substrate. In the illustrated example, said at least one generator is interposed between the substrate 3 and the membrane layer 5.

In the illustrated example, there is a plurality of such magnetic field generators 11, which are positioned on the substrate 3 according to an ordered arrangement. Each generator 11 is capable of being connected to an external electric supply source, through conductor means (not illustrated) obtained on the substrate 3.

According to an implementation mode of the invention, the generator (each generator) 11 is a planar generator, particularly a microcoil.

The generator 11 is produced particularly by a thin film deposition and processing technology. A technique to produce a planar microcoil is, for example, disclosed in U.S. Pat. No. 7,791,440.

An implementation of the device architecture can provide for manufacturing non-planar micromagnetic field generators, being manufactured by multi-layer manufacturing techniques (T. Kohlmeier et al., “An investigation on technologies to fabricate microcoils for miniaturized actuator systems”, Microsystem Technologies, Volume 10, Number 3, 175-181, 2004), or by winding a conducting wire around a columnar support (K. Kratt et al., “A fully MEMS-compatible process for 3D high aspect ratio micro coils obtained with an automatic wire bonder”, J. Micromech. Microeng. 20 (2010) 015021). In fact, non-planar microgenerators allow increasing the maximum intensity of the magnetic field produced.

In the illustrated example, the generators 11 are indirectly arranged on the surface 3a of the substrate 3, i.e., the insulating layer 7 is interposed between them and the substrate 3.

According to further not-shown implementation modes, the generators could be directly arranged on the substrate, that is, without further layers of material interposed between them and the substrate. According to other implementation modes, the generators could be arranged within the substrate, for example, formed within it, or produced separately and subsequently inserted.

The actuator 1 further comprises a support layer 9 directly or indirectly deposited on the surface 3a of the substrate 3. The support layer 9 has at least one cavity 9a inside which the planar generator 11 is arranged. The membrane layer 5 is supported by the support layer 9, and therefore has a membrane portion 5a hanging over the cavity 9a.

The support layer 9 is of a material which allows being machined in order to obtain a preset pattern for positioning the cavity/cavities. Such material can be, for example, a photoresist, such as SU-8.

In the illustrated example, in the support layer 9 there is a plurality of cavities 9a, within each of which a corresponding magnetic field generator 11 is arranged, and, consequently, there are a plurality of portions 5a, each hanging over a corresponding one of the cavities 9a.

In the illustrated example, the support layer 9 is indirectly deposited on the surface 3a of the substrate 3, i.e., the insulating layer 7 is interposed between it and the substrate 3.

According to further non-shown implementation modes, the support layer could be directly deposited on the substrate, i.e., without further layers of material interposed between it and the substrate. In this case, the cavities receiving the generators could be directly obtained on the substrate.

Preferably, the magnetic nanoparticles dispersed in the membrane layer 5 are gathered at the membrane portions 5a and, beside having a coinciding orientation, are gathered in columnar structures (FIG. 6b). This allows increasing the magnetic responsivity of the membrane. The alignment and the higher density of the nanoparticles in the membrane portions are obtained by applying an external magnetic field during the manufacturing of the actuator, in the manner that will be described in more detail herein below. In the FIGS. 6a and 6b, photographs of the nanoparticles embedded in the polymeric matrix are illustrated, with a random dispersion, and with an alignment induced by an external magnetic field, respectively.

The alignment of the nanoparticles in the polymeric matrix introduces a magnetic anisotropy (Fragouli D., Buonsanti R., Bertoni G., Sangregorio C., Innocenti C., Falqui A., Gatteschi D., Cozzoli P. D., Athanassiou A., Cingolani R., “Dynamical Formation of Spatially Localized Arrays of Aligned Nanowires in Plastic Films with Magnetic Anisotropy”, ACS Nano. 2010 Apr. 27; 4(4): 1873-8).

Furthermore, preliminary results of measurements carried out on nanocomposite membranes show that the dispersion of the nanoparticles in the PDMS matrix alters their Young's modulus; in particular, some results highlight a decrease thereof, and an improvement in elasticity (Pirmoradi et al., “A magnetic poly(dimethylesiloxane) composite membrane incorporated with uniformly dispersed, coated iron oxide nanoparticles”, Journal of Micromechanics and Microengineering, 20 015032); to that, it follows a higher deflection efficiency, that is, relevant deflections, also with weak magnetic fields.

Furthermore, due to the fact that the microgenerators are integrated within the actuator, it is possible to have them arranged in positions that are closer to the corresponding membrane portions; this may concur to the flexural efficiency of the device also for low concentration of nanoparticles in the membrane, and anyhow lower than those employed in the known devices (WO 2008/106928; Jiaxing Li, Mengying Zhang, Limu Wang, Weihua Li, Ping Sheng, Weijia Wen, “Design and fabrication of microfluidic mixer from carbonyl iron-PDMS composite membrane”, Microfluidics and nanofluidics (Oct. 11, 2010), pags. 1-7; F. Fahrni, M. W. J. Prins and L. J. van Ijzendoorn, “Magnetization and actuation of polymeric microstructures with magnetic nanoparticles for application in microfluidics”, Journal of Magnetism and Magnetic Materials, Vol. 321, No. 12, pags. 1843-1850, June 2009).

The membrane portions 5a incorporating the magnetic nanoparticles and hanging over the microcoils 11 can be mechanically actuated by a magnetic field. If no voltage is applied to the microcoils, the membrane portions remain in a rest position. If a voltage is applied, the magnetic force generated attracts or repels the nanoparticles towards the microcoils or to the opposite direction, according to the magnetic nature nanoparticles; therefore, it deflects the membrane portions 5a, as illustrated in FIG. 5. The membrane portions come back to the rest position when the electric supply is discontinued. If generators are used, which have micrometer cross-sectional dimensions, such as microcoils, it is possible to obtain a high spatial density of the generators, therefore to produce even complex deformation patterns.

A method for producing a magnetic actuator according to the invention substantially comprises the following steps:
providing a substrate,
directly or indirectly depositing on a surface of the substrate a membrane layer consisting of a matrix of polymer material, in which nanoparticles of magnetic material, capable of undergoing a dynamic effect under the action of a magnetic field, are dispersed, and applying generator means suitable for producing a magnetic field, said applying generator means comprising forming at least one magnetic field generator, directly or indirectly on said surface of the substrate, or within the substrate, before depositing the membrane layer.

In the FIGS. 1 and 5, an implementation example of the above-mentioned method is illustrated.

With reference to FIG. 1, on the substrate 3, one surface 3a of which is coated with an insulating layer 7, an array of micromagnetic field generators 11 is produced, in particular, planar microcoils. The constructive parameters of such microcoils (shape, thickness-width ratio, distance between coils, density of input current) are determined as a function of the characteristics of the desired magnetic field. Such array is coated with a photoresist layer, indicated with P in FIG. 1.

With reference to FIG. 2, through a mask M overlapping the photoresist layer P and having a coating pattern corresponding to the ordered arrangement of microcoils, the photoresist is irradiated with ultraviolet radiation. The areas that are not exposed to the ultraviolet radiation are indicated with UZ in FIG. 2. Once the device is complete, the photoresist layer P is intended to form the support layer 9 for the membrane layer 5.

With reference to FIG. 3, the membrane layer 5 incorporating the dispersed magnetic particles is deposited in a viscous form on the photo-treated photoresist layer P.

With reference to FIG. 4, the microcoils 11 area activated in order to modify the distribution and align the nanoparticles within the membrane layer 5, by they magnetic field that they create and acting on the membrane layer in a fluid condition. In fact, in such a condition, the viscosity of the polymer is low enough to allow a restricted movement of the particles with respect to the polymeric matrix. In this manner, the magnetic nanoparticles dispersed in the membrane layer 5 tend to gather at areas of the membrane layer A arranged above the microcoils 11 and to align according to the magnetic field. Once the desired configuration in terms of distribution and alignment of the nanoparticles has been reached, the microcoils 11 are inactivated, and the membrane layer 5 is immediately subjected to a hardening treatment (baking).

With reference to FIG. 5, the photoresist layer P is developed; consequently, the portions UZ which are not exposed to the ultraviolet radiation and used as a sacrificial layer are removed in order to create the cavities 9a, thereby clearing the membrane portions 5a arranged above the microcoils 11, approximately coinciding with the areas of the membrane layer A in which the magnetic nanoparticles have been previously aligned and gathered.

The inventors carried out experimental tests to study the feasibility of the alignment of the magnetic nanoparticles in a PDMS matrix before the baking thereof, by using a 25 mT magnetic field generated by an electromagnet. The results have been satisfactory and have shown the feasibility of such operation.

In order to evaluate the deflexion of the membrane under the action of an external magnetic field, the following measurement apparatus has been implemented. The PDMS nano-composite membrane has been secured under a permanent magnet, the distance of which from the membrane could be varied by using a micrometer screw. The magnetic field has been characterized as a function of the distance from the magnet, by using a gauss-O-meter. A beam emitted by a He—Ne laser has been passed between the upper surface of the membrane and the magnet, and the transmitted intensity has been detected with a photodiode. Two mirrors with a kinematic support have been used to allow an optimal alignment of the light beam, the diameter of which could further be reduced by an iris diaphragm in order to ensure the integrity of the beam passing between magnet and membrane.

Since the laser beam is parallel and grazing with respect to the membrane surface, the transmitted intensity decreases when the membrane is activated by the external magnetic field and intercepts the laser beam. Consequently, the detected variation in the intensity can constitute a qualitative measurement for the membrane deflection. In FIG. 7, the variation of the signal detected by the photodiode is reported as a function of the magnetic field. From this Figure, it is inferred that the signal detected by the photodiode decreases, therefore the membrane deflection increases, when the applied magnetic field increases.

The membrane deflection following the displacement of the permanent magnet has been taken by means of a video camera. In FIGS. 8a and 8b, two photograms of the video at two different distances of the magnet from the membrane (therefore, with different intensities of magnetic field applied on the membrane) are reported: as it can be noticed, by moving the magnet towards the membrane upper surface (therefore, increasing the intensity of the applied magnetic field), there is a progressive displacement from the rest position (represented by the bottom light-coloured line in FIGS. 8a and 8b).

The present invention can be applied, for example, to the production of tactile displays, to the manufacturing of micro-fluidic devices to pump or adjust fluid flows by means of a magnetic field, to the production of earphones and loudspeakers, or to the manufacturing of anti-counterfeit magnetic identification (ID) markers.

1-10. (canceled)

11. A magnetic actuator comprising
a substrate,
a membrane layer directly or indirectly applied on a surface of the substrate, said membrane layer consisting of a matrix of elastic polymer material in which nanoparticles of magnetic material, capable of undergoing a dynamic effect under the action of a magnetic field, are dispersed, and
a generator element for producing a magnetic field acting on the membrane layer,
wherein said generator element comprises at least one magnetic field generator directly or indirectly arranged on said surface of the substrate, or within said substrate.

12. The actuator of claim 10, wherein said at least one magnetic field generator is interposed between the substrate and the membrane layer.

13. The actuator of claim 10, further comprising a support layer directly or indirectly deposited on said surface of the substrate, said layer having at least one cavity inside of which said generator is arranged, wherein said membrane layer is supported by the support layer and has a membrane portion hanging over said cavity.

14. The actuator of claim 10, wherein said at least one generator is a planar generator.

15. The actuator of claim 10, wherein said at least one generator is a three-dimensional generator.

16. The actuator of claim 13, comprising a plurality of said generators arranged in an ordered arrangement.

17. A method for producing a magnetic actuator, comprising:
providing a substrate,
forming at least one magnetic field element, directly or indirectly on a surface of the substrate, or within said substrate, and
directly or indirectly applying on said surface of the substrate a membrane layer consisting of a matrix of polymer material, in which nanoparticles of magnetic material, capable of undergoing a dynamic effect under the action of a magnetic field, are dispersed.

18. The method of claim 17, wherein the membrane layer is deposited in a viscous state, and then subjected to a hardening treatment.

19. The method of claim 18, wherein, before subjecting the membrane layer to the hardening treatment, said at least one generator is energized to modify distribution and/or orientation of said nanoparticles within the membrane layer.

20. The method of claim 18,
wherein a support layer is directly or indirectly deposited on said surface of the substrate, in such a way as to cover said at least one generator,
wherein said membrane layer is applied directly on said support layer,
and wherein, after the hardening treatment, said support layer is selectively removed for forming at least one cavity at said at least one generator, over which said membrane has a hanging membrane portion.
